(19) United States
(12) Patent Application Publication
(10) Pub. No.: US 2019/0063611 A1
(43) Pub. Date: Feb. 28, 2019

(54) SEAL DEVICE FOR A NEGATIVE PRESSURE CALIBRATING UNIT IN AN EXTRUSION LINE

(71) Applicant: iNOEX GmbH Innovationen und Ausruestungen fuer die Extrusionstechnik, Melle (DE)

(72) Inventor: Reinhard KLOSE, Moormerland (DE)

(73) Assignee: iNOEX GmbH Innovationen und Ausruestungen fuer die Extrusionstechnik, Melle (DE)

(21) Appl. No.: 16/078,191

(22) PCT Filed: Jan. 13, 2017
(86) PCT No.: PCT/DE2017/100019

§ 371 Date: Aug. 21, 2018

(30) Foreign Application Priority Data
Mar. 4, 2016 (DE) 10 2016 103 947.0

(51) Int. Cl. F16J 15/16; B29C 47/08; B29C 47/90; B29C 47/00

(52) U.S. Cl. CPC F16J 15/168; F16J 15/164; B29C 47/0808; B29C 47/0023; B29C 47/903; B29C 47/905; B29C 47/0842

(57) ABSTRACT

The present invention relates to a seal device for a negative pressure calibrating unit in a extrusion line for producing profiled plastic sections, in particular pipes whereby the inner face of a seal rests against the circumference of the extruded profiled section in a formfitting manner and the seal is radially supported on the profiled section in order to apply a sealing force. It is the object of the invention to provide another similar device which is very easily constructed and can be produced inexpensively. This task is solved in that the seal is a porous and elastic foam body (13), the surfaces (17, 19) of that are exposed to the atmosphere are coated with an air-tight coating (21).

The present invention relates to a seal device for a negative pressure calibrating unit in a extrusion line according to the preamble of claim 1.

The plastics material exiting the extruder upon extruding which is still soft first has to be calibrated and cooled in order to achieve a high size accuracy of e.g. a plastic pipe to be produced. One of the most frequently employed methods for calibrating for this is the negative pressure calibration with spray cooling in a negative pressure calibrating unit sealed air-tight. Owing to the negative pressure prevailing inside the negative pressure calibrating unit the extruded plastic pipe is suctioned against a calibrating device arranged at the entrance of the negative pressure calibrating unit and constructed e.g. as a perforated sleeve calibrating device, as a result of which the pipe assumes a pre-determined diameter. Then, in a first cooling step, the extruded plastic pipe is further cooled in der negative pressure calibrating unit by spraying with water. At the exit of the negative pressure chamber the calibrated plastic pipe slides through a seal which seals the interior of the negative pressure calibrating unit against the atmosphere. After leaving the negative pressure calibrating unit the extruded plastic pipe is subjected to further cooling steps in downstream cooling tracks.

Modern extrusion lines allow dimensions to be changed during production operation, i.e. all relevant components of the line automatically adjust to a new to be produced dimension of a profile. This also applies to the seal at the exit of the negative pressure calibrating unit.

A sealing device of the above-described type has been described in the publication DE 10 2008 050 225 A1. This device exhibits a ring shaped half shell similar to a bicycle rim which is connected to an end wall, on the side of the entrance or of the exit, of a negative pressure calibrating unit in an air-tight manner. In the negative pressure calibrating unit an extruded profiled section is calibrated. The half shell is open in the direction facing the axis of extrusion, i.e. facing the profiled section. It houses a closed hose which can be filled with a fluid. The outer circumference of the hose is in close contact to the half sleeve and is radially supported by it. Hereby, when filled to a suitable degree, it is in form-fit contact with the circumference of the extruded profiled section. The hose is adapted to the respective currently used dimension of the extruded profiled section by corresponding modification of the degree of filling of the hose so that it is always in contact with the outer wall of the extruded profiled section with sufficient sealing force thereby attaining sufficient sealing to maintain the negative pressure in der negative pressure calibrating unit.

It is an advantage of this state of the art sealing device that is very easily constructed and can be produced inexpensively.

It is the object of the invention to provide another similar device having these advantages.

This task is solved according to the invention by a sealing device exhibiting the features of claim 1.

As the seal a porous and elastic foam body is used which, in the event of suitable radial support, rests against the circumference of the extruded profiled section in a formfitting manner by virtue of its restoring force. Moreover, since its surfaces that are exposed to the atmosphere are provided with an air-tight coating the interior of the negative pressure calibrating unit is reliably sealed off against pressure equalization with the atmosphere.

The sealing device according to the invention is very easily constructed and can, therefore, be produced inexpensively. Moreover, due to the restoring force of the foam body, in contrast to the device known from the citation DE 10 2008 050 225 A1, no operating resources in the form of fluids are required for exerting a suitable sealing force on the extruded profiled section so that any components required for handling such fluids can also be omitted. Hereby, the restoring force of the foam body is adjusted such that it rests against the circumference of the profiled section with sufficient sealing force even in the event of a change in dimensions of an extruded profiled section.

In advantageous further developments of the invention the foam body is either freely movable mounted on an embedded linkage or, alternatively, enclosed in a pressure-resistant housing.

Further advantageous embodiments of the invention can be seen from the other sub-claims.

The invention is subsequently further illustrated by means of embodiment examples. The associated drawing shows in:

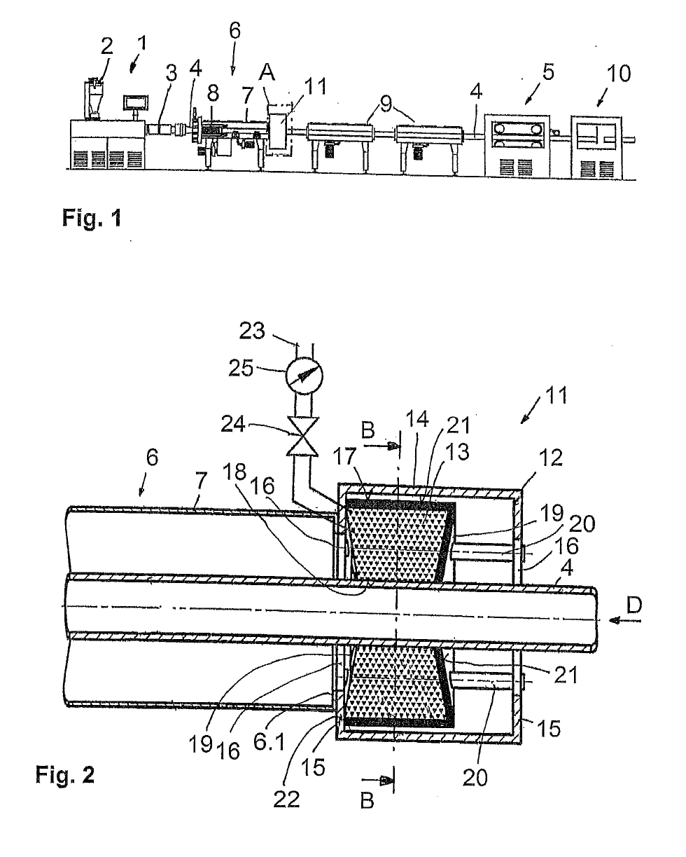

FIG. 1 a schematic representation of an extrusion plant for manufacturing plastics pipes with its main components,

FIG. 2 a schematic sectional representation of an enlarged section A according to FIG. 1 according to a first embodiment of the sealing device shown at its smallest operative pipe diameter,

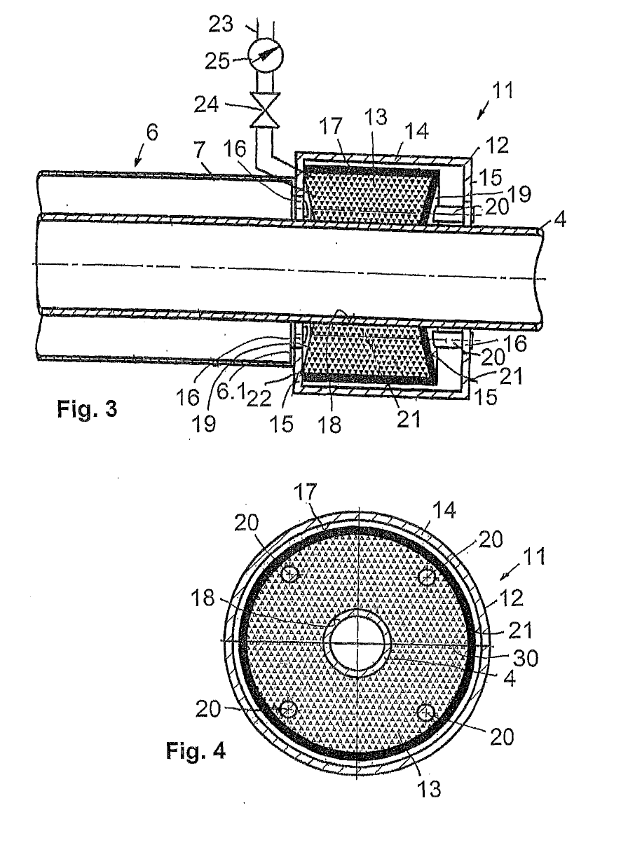

FIG. 3 a representation according to FIG. 2 with a larger operative pipe diameter,

FIG. 4 a cross-section B-B according to FIG. 2,

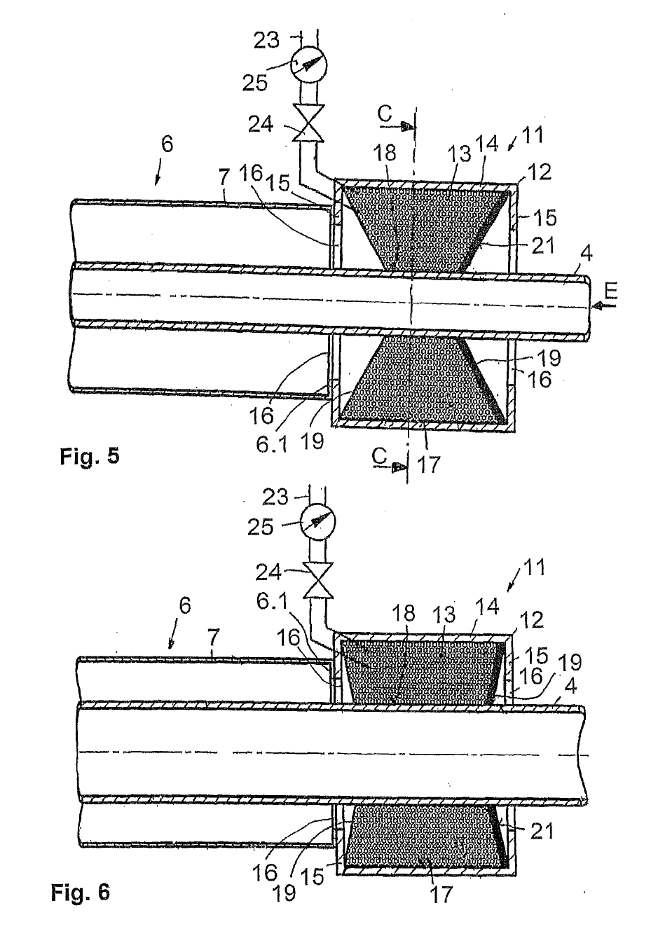

FIG. 5 a section A according to FIG. 1 according to a second embodiment of the sealing device in a schematic sectional representation at the smallest operative pipe diameter,

FIG. 6 a representation according to FIG. 5 with the largest operative pipe diameter,

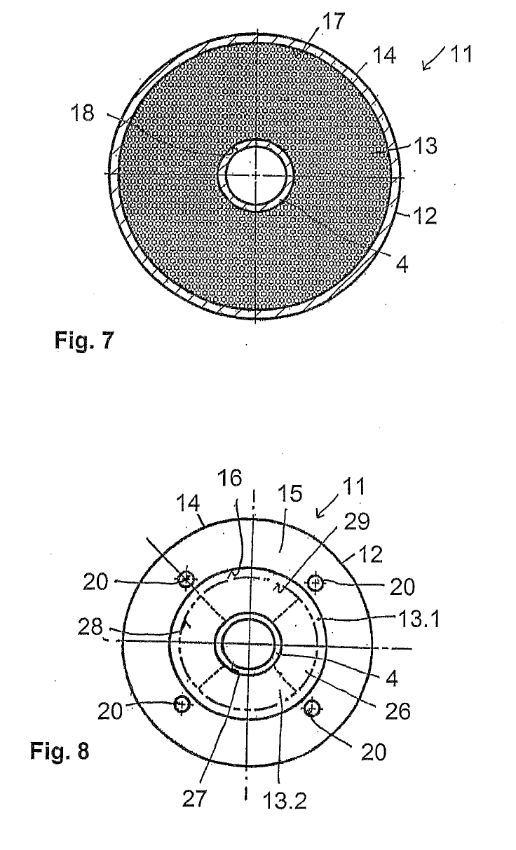

FIG. 7 a cross-section C-C according to FIG. 5,

FIG. 8 a view of the representation according to FIG. 2 in the direction of the arrow D in a third embodiment of the invention,

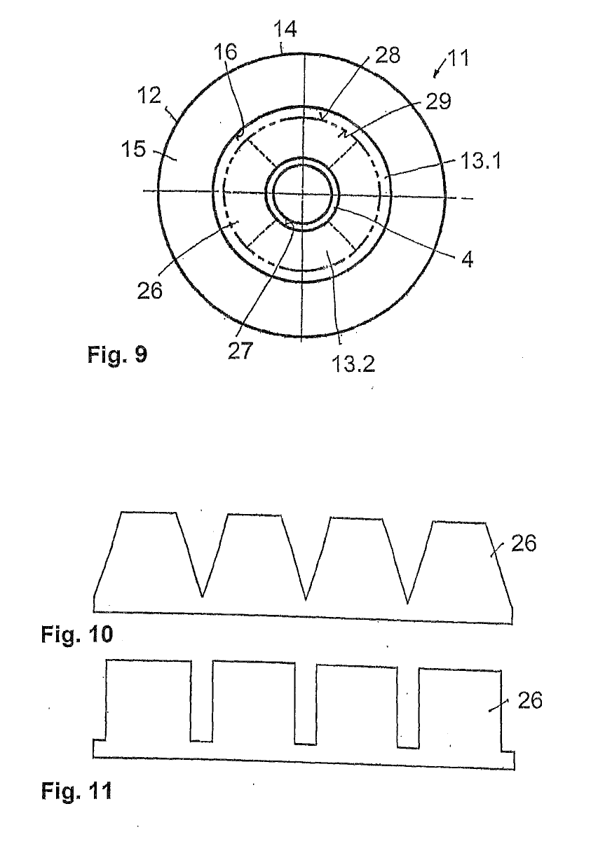

FIG. 9 a view of the representation according to FIG. 5 in the direction of the arrow E in the embodiment of the invention,

FIG. 10 a sectional lateral view of a foam mat with saw tooth tread design which constitutes the inner layer of the seal, and

FIG. 11 a sectional lateral view of a foam mat with square profile which constitutes the inner layer of the seal.

An extrusion line for plastic pipes shown in FIG. 1 includes an extruder unit 1 with a feeding hopper 2, via which a thermoplastic plastics material in the form of granulate or powder is fed to the extruder unit 1. In the extruder unit 1 the granulate or powder respectively is heated, dispersed and plasticized. Subsequently, the plastics in the form of a shapeable mass is conveyed into an extrusion die 3 and, from there, pressed through a ring-shaped and passing gap.

Upon exiting the extrusion die 3 the hot, still shapeable pipe 4 is drawn, by means of a trigger unit 5 arranged at the end of the extrusion line, through a negative pressure calibrating unit 6 which comprises a vacuum tank 7 with perforated sizing sleeve 8 arranged at its input. The diameter of the sizing sleeve 8 is continuously adjustable so that the extruded pipe 4 can be fixed at the desired value. Upon leaving the negative pressure calibrating unit 6 the pipe 4 a cooling track 9 in which it is cooled down to room temperature. At the end of the extrusion line a saw 10 is arranged in which the extruded pipe 4 is cut to a specified length.

At the exit of the negative pressure calibrating unit 6 a sealing device 11 is arranged, the construction and function of which will be illustrated below by means of two embodiment examples according to the FIGS. 2 through 4 or, respectively, the FIGS. 5 through 7, whereby, firstly, those features will be described that are common to both embodiment examples.

In embodiment examples the sealing device 11 comprises a housing 12 in which seal in the form of a porous and elastic foam body 13 is arranged. Das housing 12 has a circular cross-section with a cylindrical jacket wall 14 and two end walls 15. The end wall 15 of the housing 12 facing the der negative pressure calibrating device 6 is affixed in a pressure tight manner to an end wall 6.1 on the exit side of the negative pressure calibrating device 6. Both the exit side end wall 6.1 of the negative pressure calibrating device 6 and the two end walls 15 of the housing 12 have circular passage openings 16 the diameter of which is selected such that a pipe 4 having the largest diameter which can be operated on the line can pass tension-free.

The foam body 13 has a cylindrical outer face 17 and a cylindrical inner face 18 which are connected via two end faces 19 extending conically inwards thus having a funnel-shaped design. The purpose of the conically extending end faces 19 is to increase functional reliability in the event of a change in dimensions.

In the embodiment example according to the FIGS. 2 through 4 der foam body 13 slides on four rods or, respectively, tubes 20 distributed equally across its circumference, i.e. offset by 90 degrees. The ends of the rods or, respectively, tubes 20 are firmly affixed to the end walls 15 of the housing 12. For receiving the rods or, respectively, tubes 20 the foam body 13 is provided with corresponding through ducts not shown in the drawing.

The foam body 13 serves as a pressure equalization barrier between the negative pressure calibrating unit 6 and the atmosphere. Since it is porous and thus permeable to air, its faces that are exposed to the atmosphere must be provided with a pressure-tight coating 21. This is true for both its cylindrical outer face 17 and its end face 19 facing away from the negative pressure calibrating device 6. Furthermore, the end face 19 of the foam body 13 facing the negative pressure calibrating device 6 in the region 22 of its cylindrical outer face 17 is fixed pressure-tightly to the end wall 15 of the housing 12.

In this embodiment example, the housing 12 merely serves to protect the foam body 13 and as support structure for the rods or, respectively, tubes 20. Since it has no sealing function it could even be omitted in this case. However, an alternative would have to be provided as a corresponding support structure for the rods or, respectively, tubes 20. Moreover, the end face 19 of the foam body 13 facing the vacuum calibrating unit 6 would then have to be affixed directly to the exist side end wall 6.1 of the negative pressure calibrating device 6 in a pressure-tight manner.

The foam body 13 is radially supported on the rods or, respectively, tubes 20. Thereby, due to its elasticity, it provides sufficient restoring force so that the cylindrical inner face 18 of the foam body 13 rests against the circumference of the pipe 4 in a formfitting manner, thereby forming a seal. This situation is shown in the FIGS. 2 through 4.

If the extrusion line is to operate with a larger pipe diameter all relevant components of the line are widened accordingly. This creates a conical transition piece between the prior operated pipe diameter and the diameter to be operated from now on, and this constitutes wastage. This conical transition piece also passes the foam body 13 so that this is compressed between the gradually increasing diameter of the pipe 4 and the rods or, respectively, tubes 20 constituting counter bearings. Owing to this compression the foam body 13 expands in the direction of extrusion, i.e. its end face 19 facing away from the negative pressure calibrating unit 6 shifts in this direction while its end face 19 facing the negative pressure calibrating unit 6 stays essentially fixed in place due to its fixation on the housing 12. FIG. 3 shown this situation in which the largest operation diameter of the pipe 4 has been reached.

To improve tightness and slippage of the pipe 4 in the foam body 13 this is irrigated. To that end a water supply 23 is provided having a throttle valve 24 and a volume flow meter 25 which are shown merely symbolically.

The foam body 13 and the housing 12 are divided in a horizontal plane 30 in order to allow the sealing device 11 to be opened during the start of operation for inserting a starter pipe.

The embodiment example according to the FIGS. 5 through 7 differs from the preceding one in that the foam body 13 with its cylindrical outer face 17 is affixed to the jacket wall 14 of the housing 12 by means of a bonded connection and is supported radially on said wall as a consequence of which the inner face 18 of the foam body 13 rests against the circumference of the pipe 4, in a formfitting manner and providing a seal, due to its seiner restoring force.

On the basis of the air-tight connection of the outer face 17 of the foam body 13 on the jacket wall 14 of the housing 12 this is not exposed to the atmosphere so that, in this case, only the end face 19 of the foam body 13 facing away from the vacuum calibrating unit 6 is provided with an air-tight coating 21.

Here, too, the foam body 13 is irrigated in order to improve tightness and in order to optimize slippage of the extruded pipe 4. The irrigation happens via a water supply 23 with a throttle valve 24 and a volume flow meter 25 which are shown merely symbolically.

FIG. 5 shows the situation in the case of the smallest operated diameter of the pipe 4. When, in the event of a change of dimensions, the pipe 4 is widened up to a larger diameter then the increasing diameter of the pipe 4 exerts a radial counter-force to the restoring force of the foam body 13. This compresses the body causing its end faces 19 to shift while reducing their angle of inclination on the 4.

In FIGS. 8 through 11, two further embodiment examples are shown. These differ from the above embodiment examples in that the foam body 13 is not designed as one piece but as two pieces. Hereby, the diameter shape of the two-piece foam body 13 corresponds to the shape shown in the FIGS. 2 and 3 or, respectively, 5 and 6 with the corresponding air-tight coating 21.

In both embodiment examples the foam body 13 is provided with an outer face 13.1 in the form of a thick wall pipe with high foam density and high mechanical stability. The inner face 13.2 of the foam body 13 is formed by a foam mat 26 with saw tooth tread design according to FIG. 10 or, in the alternative, by a foam mat 26 having a square profile according to FIG. 11. The foam mat 26 is coiled to form a hollow cylinder so that the edges of the saw tooth tread or, respectively, of the square profile come into contact and a closed inner face 27 of the inner layer 13.2 is formed. The coiled up foam mat 26 is inserted into the foam tube forming the outer layer 13.1 so that a cylindrical outer face 28 of the inner layer 13.2 rests against a cylindrical inner face 29 of the outer layer 13.1, as shown in den FIGS. 8 and 9. In operation, the cylindrical inner face 27 of the inner layer 13.2 rests against the circumference of the pipe 4. The inner layer 13.2 preferably exhibits a lower mechanical stability and lower foam density than the outer layer 13.1. Moreover, the elasticity and the porosity of the inner layer 13.2 are preferably larger than that of the outer layer 13.1.

This embodiment is less sensitive when widened by a pipe 4 with a larger diameter to tensile forces occurring radially.

In the embodiment example according to FIG. 8, like in the embodiment example according to FIGS. 2 through 4, the outer layer 13.1 of the foam body 13 ix penetrated by four rods or, respectively, tubes 20 on which the outer layer 13.1 can slide taking with it the inner layer 13.2 by sticking friction or bonding connection, such as gluing. The outer layer 13.1 is radially supported by the rods or, respectively, tubes 20 radial so that the inner layer 13.2 resting on its inner face 29 is also radially supported and its restoring force makes for a sealing contact of its inner face 27 with the circumference of the pipe 4.

In the embodiment example according to FIG. 9 the radial support is created by the outer layer 13.1 resting against the jacket wall 14 of the housing 12.

The subsequent embodiment examples are not shown in the drawing.

According to a further embodiment example of the invention the foam structure of the foam body 13 can be constructed as locally having differing hardness and/or elasticity and/or differing volumetric weight and/or reinforcement elements, in order to achieve a desired functionality.

According to a further embodiment example of the invention the inner face 18 of the foam body 13 may exhibit a wear-resistant coating.

According to a further embodiment example of the invention the foam body 13 may be designed to be profiled or wavelike in the region of its inner face 18, in order to reduce frictional forces in the region of the seal.

1. A sealing device for a negative pressure calibrating unit in an extrusion line for producing profiled plastic sections, in particular pipes, whereby the inner face of a seal rests against the circumference of the extruded profiled section in a formfitting manner and the seal is radially supported on the profiled section in order to apply a sealing force, wherein the seal is a porous and elastic foam body (13), the surfaces (17, 19) of that are exposed to the atmosphere are coated with an air-tight coating (21).

2. The sealing device according to claim 1, wherein the foam body (13) includes an outer surface (17) covered by an air-tight coating (21), said surface being connected, via a first end surface (19) facing the negative pressure calibrating unit (6) and a second end surface (19) facing away from the von der negative pressure calibrating unit (6) and having an air-tight coating (21), to an inner face (18), whereby said first end surface (19) in the region of the outer surface (17) of the foam body (13) is affixed in an air-tight manner to an end surface (6.1) on the exist side of the negative pressure calibrating unit (6) or to a component connected thereto, and the foam body (13) is permeated by at least three rods or tubes (29) distributed over its circumference and aligned parallel to the extruded profiled section (4), and said foam body being radially supported in a sliding mounted manner on said rods or tubes.

3. The sealing device according to claim 1, wherein the foam body (13) includes an outer surface (17) radially supported on a jacket wall (14) connected in an air-tight manner to the exist side end wall (6.1) of a housing (12) of the negative pressure calibrating unit (6) and connected to an inner face (18) via a first end wall (19) facing the negative pressure calibrating unit (6) and a second end wall (19) facing the negative pressure calibrating unit (6) and provided with an air-tight coating (21).

4. The sealing device according to claim 3, wherein the outer face (17) of the foam body (13) is connected to the jacket wall (14) in a formfitting manner.

5. The sealing device according to claim 1, wherein the foam body (13) and the housing (12) are divided in a horizontal plane (30).

6. The sealing device according to claim 1, wherein the foam body (13) is irrigated.

7. The sealing device according to claim 1, wherein the foam structure of the foam body (13) is constructed as locally having differing hardness and/or elasticity and/or differing volumetric weight and/or reinforcement elements.

8. The sealing device according to claim 1, wherein the inner face (18) of the foam body (13) exhibits a wear-resistant coating.

9. The sealing device according to claim 1, wherein the foam body (13) is designed to be profiled or wavelike in the region of its inner face (18).

10. The sealing device according to claim 1, wherein the end faces (19) of the foam body (13) are designed to be conical.
